(19) United States
(12) Patent Application Publication
(10) Pub. No.: US 2015/0229062 A1
(43) Pub. Date: Aug. 13, 2015

(54) USB WALL OUTLET ASSEMBLY

(71) Applicant: Antonious Hood, Killeen, TX (US)

(72) Inventor: Antonious Hood, Killeen, TX (US)

(21) Appl. No.: 14/174,954

(22) Filed: Feb. 7, 2014

(51) Int. Cl. H01R 13/447; H02G 3/08

(52) U.S. Cl. CPC H01R 13/447; H02G 3/081

(57) ABSTRACT

An USB wall outlet assembly comprising: a wall housing; USB cords leading into a rear wall of the wall housing; at least two USB outlets available within the wall housing; and a front plate where the front plate provides access to the USB outlets. The USB wall outlet assembly may further include a lock and push button release incorporated with a cover so that the USB outlets may be covered when not in use.

### BACKGROUND OF THE INVENTION

1. Field of Invention

The present invention likes to a wall outlet assembly for a USB connection and connectivity.

2. Description of Related Art

The universal serial bus (USB) is a connective system that is utilized in computers and cables for connection of peripheral components typically used with a computer. Among other things, a USB connection enables the connection of external memory into a computer. The USB connection is typically used on both desktops and laptops to connect any peripheral devices such as a keyboard, mouse, speakers and other items. USB connectors are also used with personal electronic devices such as PDAs, game consoles and smart phones. The USB cord provides connectivity for both data and power. A power exchange is provided through the USB to connect it to the computer and may also allow for the data and control features associated with the peripheral equipment.

The USB connectors are used extensively with smart phones. Smart phone usage has grown rapidly in the personal communications industry and usually includes the use of USB connectivity so that the individual may sync data on the phone with a computer and/or for charging the battery of the smart phone. Further the USB connection has been implemented in many motor vehicles to allow the syncing and charging of portable electronic such as the smart phone. Consequently, the USB connector has been used more frequently for a power supply and charger in addition syncing and connectivity with a computer. In certain instances, a power connector is provided to connect a USB cord to a standard 110 v outlet to supply power to a portable electronic device at the opposite end. One advantageous modification of this system would be providing a wall outlet that is wired directly into the electrical system of a building so that an individual may directly connect the USB connector to a USB outlet provided in the wall. Such a system therefore could provide more widespread use of the USB connector in building systems.

### SUMMARY OF THE INVENTION

The present invention relates to a USB wall outlet assembly. The wall outlet assembly includes a wall housing that receives USB cords leading into one side of the wall housing. The USB outlet assembly includes at least two USB outlets available for connection. A front plate is provided for the USB wall housing and the front plate provides the user with access to the USB connections within the housing. The housing, in one particular embodiment, is rectangular in shape.

### BRIEF DESCRIPTION OF DRAWINGS

FIG. 1 depicts a side view of a USB wall outlet in accordance with the present invention.

FIG. 2 provides a front view of a USB wall outlet in accordance with the present invention.

FIG. 3 depicts a USB outlet that includes a front cover in accordance with the present invention.

### DETAILED DESCRIPTION

The present invention relates to a USB wall outlet assembly. The wall outlet assembly includes a wall housing that surrounds and secures USB outlets within the housing. Cords extend from the rear side of the housing and supplies power to the USB outlets. The USB outlet includes a front plate that secures the outlets within the housing and may further include a lock mechanism in order to lock a cover onto the front side of the USB outlet.

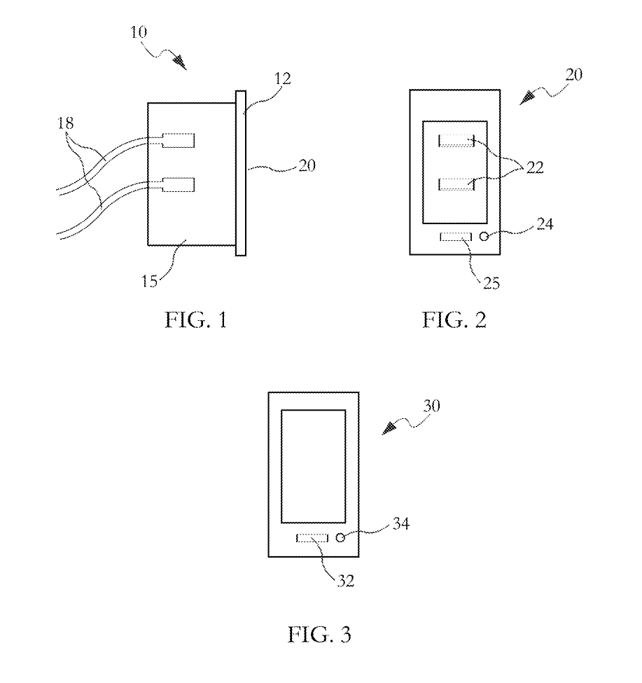

In reference to FIG. 1, a USB wall outlet assembly 10 is depicted. The USB wall outlet assembly 10 includes wires 18 extending into a USB housing 15. The USB housing 15 includes a front plate 20 that has a lip 12, where the lip 12 extends around the outer portion of the housing 15.

FIG. 2 depicts a front view of the front plate 20. As shown, the front plate 20 surrounds two USB connections 22. The USB connections 22 are available for connection and allow the user access to the USB connectivity. A lock 25 and push button release 24 was shown along the bottom portion of the front plate 20. The lock 25 and push button release 24 are used in conjunction with a cover 30 as shown in FIG. 3. Cover 30 shows push button 34 and lock cover 32 that covers the push button release 24. The push button 34 releases the cover from the front plate 20. Front plate 30 may be placed over the USB connections in order to provide a protective cover when the USB outlets are not in use. The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed:

1. A USB wall outlet assembly comprising:
a wall housing;
USB cords leading into a rear wall of the wall housing;
at least two USB outlets available within the wall housing; and
a front plate where the front plate provides access to the USB outlets.

2. The USB wall outlet assembly according to claim 1, further including a lock and push button release.

3. The USB wall outlet assembly according to claim 2, further including a cover capable of being locked in place.
